(19) United States
(12) Patent Application Publication
(10) Pub. No.: US 2025/0365384 A1
(43) Pub. Date: Nov. 27, 2025

(54) METHOD FOR CREATING PROOF IMAGE DATA, PROOF IMAGE DATA CREATION DEVICE, AND COMPUTER PROGRAM

(71) Applicant: SEIKO EPSON CORPORATION, TOKYO (JP)

(72) Inventors: Yuko YAMAMOTO, SHIOJIRI-SHI (JP); Takuya ONO, SHIOJIRI-SHI (JP); Takahiro KAMADA, MATSUMOTO-SHI (JP); Mitsuhiro YAMASHITA, MATSUMOTO-SHI (JP)

(21) Appl. No.: 19/215,469

(22) Filed: May 22, 2025

(30) Foreign Application Priority Data
May 22, 2024 (JP) 2024-083240

(51) Int. Cl. H04N 1/60; G06T 5/70

(52) U.S. Cl. CPC H04N 1/6011; G06T 5/70

(57) ABSTRACT

A method for creating proof image data includes: (a) acquiring basic proof image data for reproducing, by a proof output device, a color of a printed matter to be printed on a printing medium using a printing machine; and (b) creating, by applying bleed applying processing to the basic proof image data using a bleed parameter representing a bleed state of an ink in the printed matter, bleed-applied proof image data simulating the bleed state.

The present application is based on, and claims priority from JP Application Serial Number 2024-083240, filed May 22, 2024, the disclosure of which is hereby incorporated by reference herein in its entirety.

### BACKGROUND

### 1. Technical Field

The present disclosure relates to a method for creating proof image data, a proof image data creation device, and a computer program.

### 2. Related Art

JP-A-09-270930 discloses a method for creating a proof image for proofreading a printed matter. In the related art, a proof image is created by correcting an image based on a density distribution on a two-dimensional space of a surface of a printed matter printed on a printing medium at a density of 100%.

JP-A-09-270930 is an example of the related art.

However, the inventor of the disclosure has found that an influence of bleed is taken into consideration when creating a proof image because the influence of bleed of an ink is large in a printed matter printed on a specific printing medium such as fabric. The bleed occurs due to spreading of the ink, mixing with another adjacent ink, or flowing of the ink due to an influence of unevenness of the printing medium before the ink landed on the printing medium permeates into the printing medium. Therefore, in order to faithfully reproduce a state of the printed matter, it is desirable to reflect the influence of bleed in proof image data.

### SUMMARY

According to a first aspect of the disclosure, a method for creating proof image data is provided. The method includes: (a) acquiring basic proof image data for reproducing, by a proof output device, a color of a printed matter to be printed on a printing medium using a printing machine; and (b) creating, by applying bleed applying processing to the basic proof image data using a bleed parameter representing a bleed state of an ink in the printed matter, bleed-applied proof image data simulating the bleed state.

According to a second aspect of the disclosure, a proof image data creation device is provided. The proof image data creation device includes: a basic proof image acquisition unit configured to acquire basic proof image data for reproducing, by a proof output device, a color of a printed matter to be printed on a printing medium using a printing machine; and a bleed processing unit configured to create, by applying bleed applying processing to the basic proof image data using a bleed parameter representing a bleed state of an ink in the printed matter, bleed-applied proof image data simulating the bleed state.

According to a third aspect of the disclosure, a computer program for creating proof image data is provided. The computer program causes a computer to execute: (a) processing of acquiring basic proof image data for reproducing, by a proof output device, a color of a printed matter to be printed on a printing medium using a printing machine; and (b) processing of creating, by applying bleed applying processing to the basic proof image data using a bleed parameter representing a bleed state of an ink in the printed matter, bleed-applied proof image data simulating the bleed state.

### BRIEF DESCRIPTION OF THE DRAWINGS

FIG. 1 is a diagram showing a printing system for proofreading a printed matter.

FIG. 2 is a block diagram showing a configuration of a proof image data creation device.

FIG. 3 is a diagram showing a flow of proof image creation processing.

FIG. 4 is a diagram showing an example of a basic proof image.

FIG. 5 is a diagram showing an example of texture information.

FIG. 6 is a diagram showing an example of a bleed parameter setting screen.

FIG. 7 is a diagram showing an example of bleed applying processing in a bleed mode M1.

FIG. 8 is a diagram showing an example of the bleed applying processing in a bleed mode M2.

FIG. 9 is a diagram showing another example of the bleed applying processing in the bleed mode M2.

FIG. 10 is a diagram showing an example of the bleed applying processing in a bleed mode M2a.

FIG. 11 is a diagram showing an example of the bleed applying processing in a bleed mode M3.

FIG. 12 is a diagram showing an example of the bleed applying processing in a bleed mode M4.

FIG. 13 is a flowchart showing a procedure of creation processing on proof image data.

FIG. 14 is a flowchart showing a detailed procedure of the bleed applying processing.

### DESCRIPTION OF EMBODIMENTS

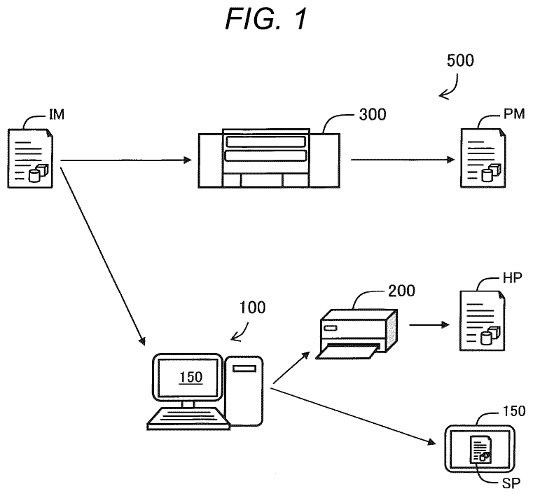

FIG. 1 is a diagram showing a printing system 500 for proofreading a printed matter. The printing system 500 includes a printing machine 300 that prints a printed matter PM according to input image data IM, a proof image data creation device 100 that creates proof image data using the input image data IM, and a proofreading printing device 200. The proofreading includes a hard proof that prints a proofreading printing HP using the proofreading printing device 200 and a soft proof that displays a proof image SP on a display device 150 according to the proof image data. In the hard proof, the proofreading printing device 200 corresponds to a “proof output device”, and in the soft proof, the display device 150 corresponds to a “proof output device”. An image output from the proof output device is also referred to as an “output image”. The proofreading printing HP corresponds to the “output image” in the hard proof, and the proof image SP corresponds to the “output image” in the soft proof.

The proof image data creation device 100 can execute at least one of the hard proof and the soft proof. In the hard proof, the proofreading printing device 200 prints the proofreading printing HP according to the proof image data created by the proof image data creation device 100. When the proofreading printing device 200 is an inkjet printer, the proof image data creation device 100 creates dot data for printing by applying color conversion processing or halftone processing to the proof image data, and supplies the dot data to the proofreading printing device 200 to execute printing of the proofreading printing HP. In the soft proof, the proof image SP is displayed on the display device 150 according to the proof image data created by the proof image data creation device 100. The disclosure is applicable to both the hard proof and the soft proof.

The printing machine 300 is, for example, a textile printing machine that performs textile printing on a fabric printing medium. An influence of ink bleed is large in the printed matter PM printed on the fabric printing medium. The proof image data creation device 100 creates proof image data to which bleed is applied in order to faithfully reproduce a state of the printed matter PM. However, the disclosure is also applicable to a case where the printing machine 300 performs printing on a printing medium other than fabric.

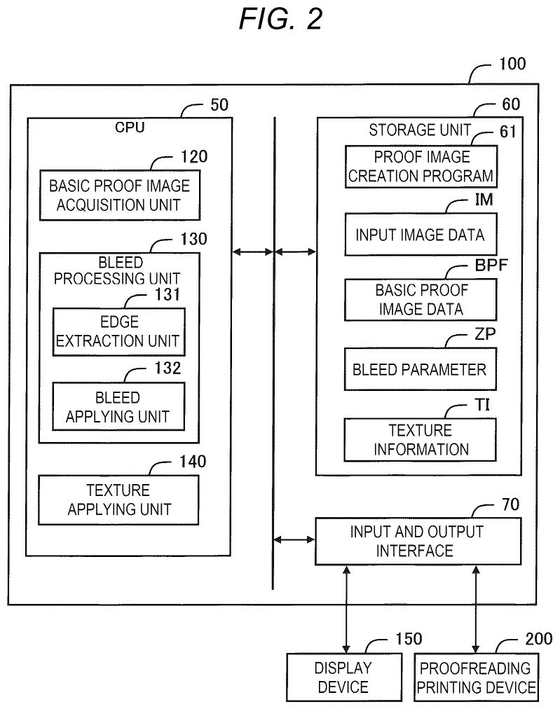

FIG. 2 is a block diagram showing a configuration of the proof image data creation device 100. The proof image data creation device 100 is a computer including a CPU 50, a storage unit 60, and an input and output interface 70. The CPU 50, the storage unit 60, and the input and output interface 70 are connected to one another via an internal bus so as to be capable of bidirectional communication.

The CPU 50 functions as a basic proof image acquisition unit 120, a bleed processing unit 130, and a texture applying unit 140 by executing a proof image creation program 61 stored in advance in the storage unit 60. The bleed processing unit 130 includes an edge extraction unit 131 and a bleed applying unit 132. At least a part of the functions of these units 120 to 140 may be implemented by a hardware circuit or may be implemented on a cloud.

The input and output interface 70 is connected to the display device 150 and the proofreading printing device 200 in a wired or wireless manner. The display device 150 is used to display a window and a proof image described later.

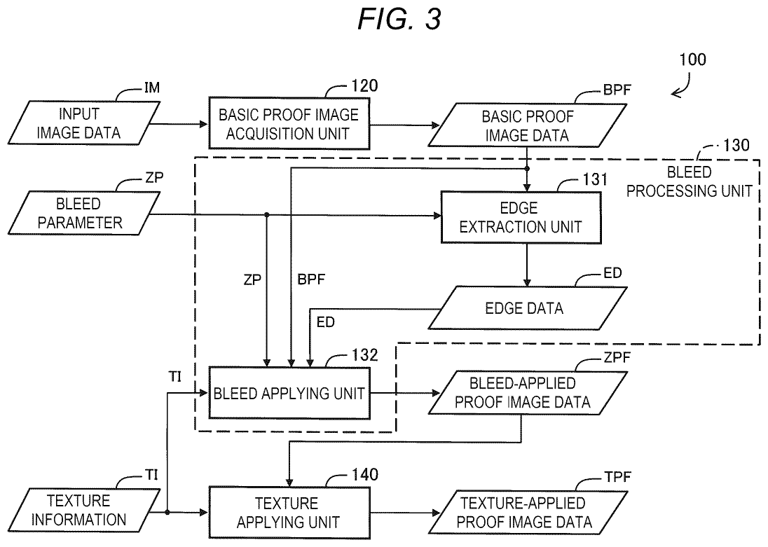

FIG. 3 is a diagram showing a flow of proof image creation processing. The basic proof image acquisition unit 120 acquires basic proof image data BPF. The basic proof image data BPF is data in which a difference in color reproduction between the printing machine 300 and the proof output device is reflected in the input image data IM. In other words, the basic proof image data BPF is data for reproducing, by the proof output device, the color of the printed matter printed on the printing medium using the printing machine 300. However, the basic proof image data BPF does not reflect ink bleed and texture information on the printing medium. In the embodiment, the basic proof image acquisition unit 120 creates the basic proof image data BPF from the input image data IM. In the creation processing, for example, various ICC profiles such as an input profile of the input image data IM, a device profile and a media profile of the proof output device, and a media profile of the printing machine 300 that prints the printed matter PM are used. However, when the basic proof image data BPF has already been created, the basic proof image acquisition unit 120 may acquire the basic proof image data BPF by reading the basic proof image data BPF from the storage unit 60.

Any method can be used as a method for creating the basic proof image data BPF. For example, the method described in Japanese Patent Application No. 2022-194704 disclosed by the applicant of the disclosure may be used. In this method, the following processing is sequentially executed.

### Processing P1

First image data is acquired by converting a color space of the input image data IM into an output color space of the printing machine 300 using the ICC profile.

### Processing P2

Second image data expressed in an absolute XYZ color space is acquired by performing, on the first image data, conversion using a first conversion table into an expression in a profile connection space and white point conversion using information on an appearance in a predetermined observation environment of a ground color portion in which an image is not formed in the printed matter PM.

### Processing P3

The second image data is converted into converted image data expressed in the output color space of the proof output device by using a second conversion table. The output color space of the proof output device is, for example, a CMYK color space or an RGB color space. The second image data or the converted image data can be used as the basic proof image data BPF.

The proof image may be created by using the method described in the related art (JP-A-09-270930) or JP-A-2006-30277. When the method in the related art is used, the basic proof image data BPF in which the texture is not reflected can be created by executing processing in which first correction and second correction related to a texture of a sheet are omitted.

In the embodiment, the basic proof image data BPF is expressed in an L*a*b* color space. When the basic proof image data expressed in the output color space of the proof output device is created using the above-described various methods, the output color space of the proof output device can be converted into the L*a*b* color space using an output profile of the proof output device. When the method described in Japanese Patent Application No. 2022-194704 is used, a color space of the second image data expressed in the absolute XYZ color space may be converted into the L*a*b* color space.

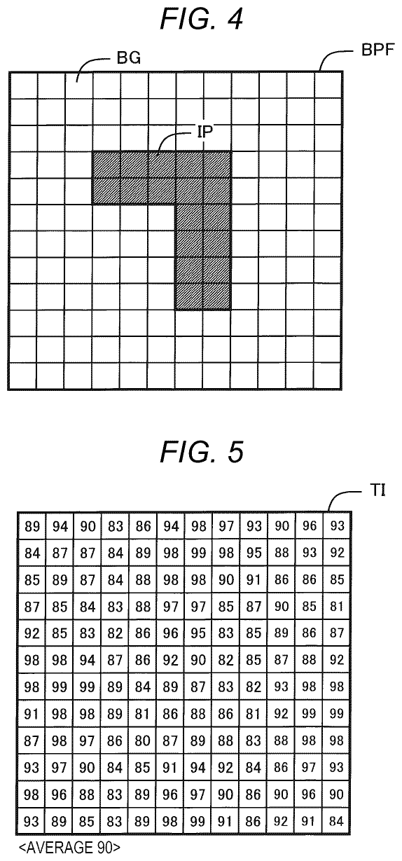

FIG. 4 is a diagram showing an example of a basic proof image represented by the basic proof image data BPF. The basic proof image data BPF represents the basic proof image in which a dark ink ejection region IP is printed on a background BG. In the embodiment, the basic proof image data BPF is expressed in the L*a*b* color space. For example, the background BG is a white region of L*=90, and the ink ejection region IP is a gray region of L*=25.

As shown in FIG. 3, the bleed processing unit 130 applies bleed applying processing to the basic proof image data BPF to create bleed-applied proof image data ZPF simulating a bleed state. The bleed processing unit 130 includes the edge extraction unit 131 and the bleed applying unit 132.

The edge extraction unit 131 extracts an edge of the basic proof image represented by the basic proof image data BPF to generate edge data ED representing the edge. As edge extraction processing, for example, one or more of the following processing can be used.

### Edge Extraction Processing Using Difference Between Pixel Values

In the basic proof image, a brightness difference or a color difference between adjacent pixels is obtained, and a pixel whose brightness difference or color difference is equal to or larger than a threshold is extracted as an edge pixel. In the edge extraction processing using the brightness difference, a difference in a brightness L* between the basic proof image and a shifted image obtained by shifting the basic proof image by one pixel is obtained, and a pixel whose absolute value of the brightness difference is equal to or larger than the threshold is determined as a candidate pixel. When the brightness difference is plus, the candidate pixel is extracted as the edge pixel. On the other hand, when the brightness difference is minus, a pixel moved by one pixel from the candidate pixel in a direction opposite to a shift direction is extracted as the edge pixel. This edge extraction processing is executed for a case where pixels are shifted in a vertical direction and a case where pixels are shifted in a horizontal direction. The same applies to the edge extraction processing using the color difference.

### Edge Extraction Processing Using Edge Extraction Filter

Edge pixels included in the basic proof image are extracted using an edge extraction filter.

### Edge Extraction Processing for Character

When the basic proof image data BPF includes character data representing a character, pixels constituting a contour of the character are extracted as the edge pixels.

In the example of FIG. 4, all pixels constituting the dark ink ejection region IP are extracted as the edge pixels.

The bleed applying unit 132 applies the bleed applying processing to the basic proof image data BPF using a bleed parameter ZP representing the bleed state of the ink in the printed matter PM printed by the printing machine 300, thereby creating the bleed-applied proof image data ZPF simulating the bleed state. The bleed parameter ZP is set by a user using a bleed parameter setting screen described later. In the bleed applying processing, the edge data ED and texture information TI are also referred to in addition to the bleed parameter ZP. An example of the bleed applying processing will be described later.

The texture applying unit 140 creates texture-applied proof image data TPF simulating a texture by applying processing of applying, using the texture information TI, the texture of the printing medium to the bleed-applied proof image data ZPF obtained by the bleed applying processing. As texture applying processing, for example, the same processing as the processing disclosed in JP-A-06-86045 can be used. Specifically, a value obtained by multiplying a difference between an average value of texture values and the individual texture values by a gain may be added to a pixel value of the bleed-applied proof image data ZPF. The texture may be applied according to another known method. When the bleed-applied proof image data ZPF is expressed by a CIE-L*a*b* color system, the texture applying processing may be executed only for the brightness L*. When the bleed-applied proof image data ZPF is expressed by an RGB color system, the texture applying processing may be executed for each color component of RGB.

FIG. 5 is a diagram showing an example of the texture information TI. As the texture information TI, a Height Map used in 3D rendering, or a brightness value map generated based on image data obtained by imaging a printing medium can be used. In any case, it is preferable that the texture information TI is implemented as a texture value map indicating unevenness of the printing medium. In the example of FIG. 5, the texture value assigned to each pixel is the brightness L*. A pixel having a high brightness L* corresponds to a convex portion, and a pixel having a low brightness L* corresponds to a concave portion. However, a value in a range of 0 (dark) to 100 (bright) may be adopted as the texture value. An image region of the texture information TI preferably has a size including the basic proof image.

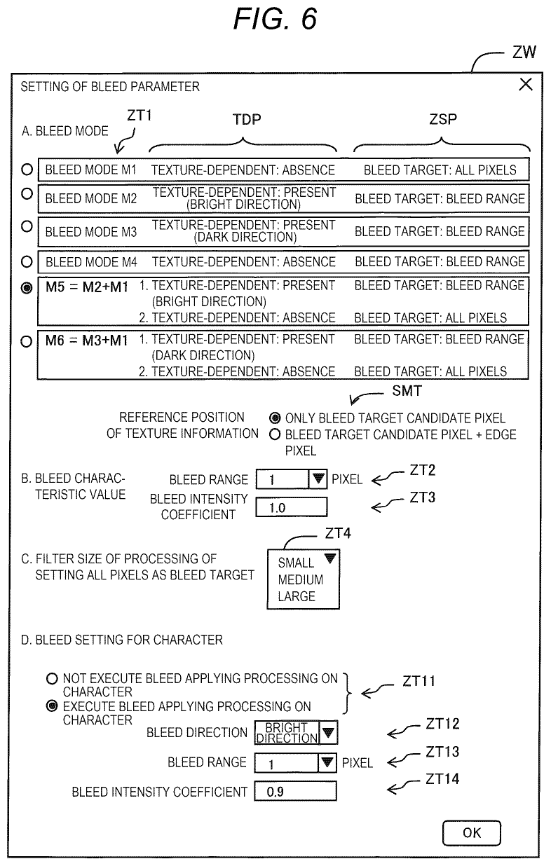

FIG. 6 is a diagram showing an example of a bleed parameter setting screen ZW. The bleed parameter setting screen ZW includes a selection tool ZT1 of “A. bleed mode”, setting tools ZT2 and ZT3 of “B. bleed characteristic value”, a setting tool ZT4 of “C. filter size of processing of setting all pixels as bleed target”, and setting tools ZT11 to ZT14 of “D. bleed setting for character”.

The selection tool ZT1 of “A. bleed mode” can select any one of a plurality of bleed modes M1 to M6. Options of the individual bleed modes include a texture-dependent designation parameter TDP and a bleed target parameter ZSP.

The texture-dependent designation parameter TDP is a parameter for designating the presence or absence of texture-dependent. In the embodiment, the texture-dependent designation parameter TDP is any one of three values of “texture-dependent: absence”, “texture-dependent: presence (bright direction)”, and “texture-dependent: presence (dark direction)”. The “texture-dependent: absence” means that the bleed applying processing is executed without depending on the texture information TI. The “texture-dependent: present (bright direction)” means processing of applying bleed to a bleed target candidate pixel when the brightness L* of the texture value of the bleed target candidate pixel adjacent to the edge pixel is larger than a preset threshold. The “texture-dependent: present (dark direction)” means processing of applying bleed to a bleed target candidate pixel when the brightness L′ of the texture value of the bleed target candidate pixel adjacent to the edge pixel is equal to or smaller than the threshold. The bright direction is also referred to as an “increasing direction”, and the dark direction is also referred to as a “decreasing direction”.

When the texture information TI represents the brightness of the printing medium, there is a tendency that bleed is likely to occur in a pixel having a high brightness, and thus dependency of the “bright direction (increasing direction)” is normally used as the texture-dependent. When the texture information TI is the Height Map, there is a tendency that bleed is likely to occur in a pixel having a large height, and thus the “bright direction (increasing direction)” is normally used as the texture-dependent. However, the “dark direction (decreasing direction)” may be preferable as the texture-dependent.

A case where the texture-dependent is the “bright direction” is, for example, a case where the ink bleeds along a thread of a weave of a fabric which is a printing medium. In the texture information TI, a convex portion in unevenness of the weave has a high brightness. For example, when a fabric having rough stitches, since positions of the threads are bright pixels and ink bleed occurs along the threads, the texture-dependent is the “bright direction”. On the other hand, a case where the texture-dependent is the “dark direction” is, for example, a case where the ink bleeds along a groove of a weave of a fabric which is a printing medium. That is, when a speed at which the ink is absorbed by the groove is higher than a speed at which the ink is absorbed by the threads, the ink may bleed in the dark direction.

Whether the texture-dependent is the “bright direction” or the “dark direction” depends on a type of the printing medium or a type of the ink. The type of the printing medium is determined by a material of the thread, a knitting method, a pretreatment, and the like. The pretreatment is a treatment in which a chemical agent is applied and dried before printing for the purpose of fixing an ink to a fabric and the like. In practice, it is preferable that the user selects one of the “bright direction” and the “dark direction” by checking a bleed direction occurs when printing is actually performed.

The “texture-dependent: present (bright direction)” and the “texture-dependent: present (dark direction)” are parameters indicating whether to apply the bleed according to whether a magnitude relationship between the texture value and the threshold is a first magnitude relationship or a second magnitude relationship. For example, the first magnitude relationship is a relationship in which the texture value is larger than the threshold, and the second magnitude relationship is a relationship in which the texture value is equal to or smaller than the threshold. The “texture-dependent: present (bright direction)” and the “texture-dependent: present (dark direction)” are also referred to as “bleed direction parameters”.

The bleed target parameter ZSP is a parameter for designating whether the bleed target is “all pixels” or a “bleed range”. When the bleed target is “all pixels”, the bleed is applied to all pixels, as a target, of the basic proof image represented by the basic proof image data BPF. When the bleed target is the “bleed range”, a pixel adjacent to the edge pixel and present in the “bleed range” is the bleed target candidate pixel.

A selection tool SMT for a reference position of the texture information is provided below the options of the plurality of bleed modes M1 to M6. Here, as options of the reference position of the texture information, two options of “only bleed target candidate pixel” and “bleed target candidate pixel+edge pixel” are provided. When the reference position of the texture information is “only bleed target candidate pixel”, only the texture value in the bleed target candidate pixel is referred to, and it is determined whether the bleed is applied to the bleed target candidate pixel. As described above, the bleed target candidate pixel is a pixel adjacent to the edge pixel and present in the “bleed range”. When the reference position of the texture information is the “bleed target candidate pixel+edge pixel”, the texture values of both the bleed target candidate pixel and the edge pixel are referred to, and it is determined whether the bleed is applied to the bleed target candidate pixel. A specific example thereof will be described later.

As the setting tool of “B. bleed characteristic value”, the setting tool ZT2 of “bleed range” and the setting tool ZT3 of “bleed intensity coefficient” are provided. In the example of FIG. 6, the “bleed range” is set to one pixel, and the bleed intensity coefficient is set to 1.0. The “bleed range” can be set to any number of pixels of one or more pixels. However, instead of designating the “bleed range” by the number of pixels, an option such as “small, medium, large” may be displayed, and the number of pixels may be calculated according to the option and a resolution of the proof image. Instead of designating the “bleed range” by a pixel value, a difference designated value of a color difference AE, a brightness difference, or a saturation difference may be designated as a difference pixel value between the edge pixel and a white pixel in the basic proof image data BPF. In this case, among the pixels adjacent to the edge pixel, a pixel whose difference pixel value is equal to or smaller than a designated value is a bleed applying target.

When the bleed target is “all pixels”, the bleed applying processing for all pixels of the proof image is executed using a blurring filter. A size of the blurring filter is set by using the setting tool ZT4 of “C. filter size of processing of setting all pixels as bleed target”. In the example of FIG. 6, the filter size is set to “small”.

As the setting tool of “D. bleed setting for character”, the setting ZT11 for designating whether to execute the bleed applying processing on a character, the setting tool ZT12 for a bleed direction, the setting tool ZT13 for a bleed range, and the setting tool ZT14 for a bleed intensity coefficient are provided. However, a simple setting tool for selecting an option such as “weak bleed” or “no bleed” may be used. In this case, it is preferable that a fine setting value corresponding to each option is set in advance.

The bleed applying processing for a character is processing of, when the basic proof image data BPF includes character data representing the character, extracting pixels constituting a contour of the character as edge pixels and applying bleed. The user may designate the edge pixels of the character using a graphical user interface (GUI). The edge pixels may be extracted using a detection tool that automatically detects a character in an image. When execution of the bleed applying processing on the character is designated, the setting by the setting tools ZT1 to ZT4 is not applied to the character, and the bleed applying processing is executed according to the setting by the setting tools ZT11 to ZT14 of “D. bleed setting for character”. As described above, when the bleed applying processing is executed on the character according to a setting different from that of other image portions, bleed suitable for the character can be applied.

Hereinafter, an example of the bleed applying processing in the plurality of bleed modes M1 to M6 will be sequentially described. In the following description, it is assumed that in the plurality of bleed modes M1 to M6, “only bleed target candidate pixel” is selected as an initial setting as the reference position of the texture information. A case where the “bleed target candidate pixel+edge pixel” is selected as the reference position of the texture information will be described as an auxiliary mode of any bleed mode.

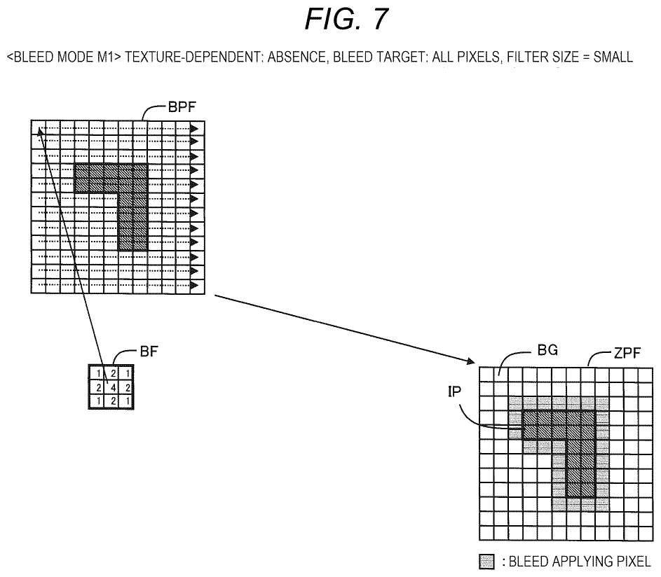

FIG. 7 is a diagram showing an example of the bleed applying processing in the bleed mode M1. The bleed mode M1 is a mode of “texture-dependent: absence” and “bleed target: all pixels”. In this example, the filter size is set to “small”. As a blurring filter BF, a Gaussian filter of 3×3 pixels is exemplified. Instead of the Gaussian filter, another blurring filter such as an averaging filter may be used. The blurring filter is also referred to as a “smoothing filter”. In the bleed applying processing in the bleed mode M1, the blurring filter BF is sequentially applied to all the pixels of the basic proof image to create the bleed-applied proof image data ZPF. As a result, a pixel adjacent to the edge pixel of the dark ink ejection region IP is a bleed applying pixel.

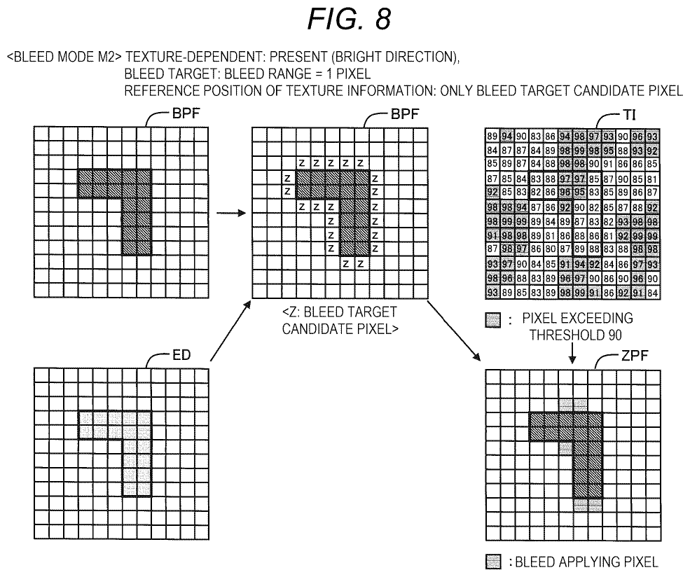

FIG. 8 is a diagram showing an example of the bleed applying processing in the bleed mode M2. The bleed mode M2 is a mode of “texture-dependent: present (bright direction)” and “bleed target: bleed range”. In this example, “bleed range=1 pixel” and “reference position of texture information: only bleed target candidate pixel” are set. A bleed target candidate pixel Z is a pixel adjacent to the edge pixel of the basic proof image and within a range of one pixel from the edge pixel. Since “texture-dependent: present (bright direction)”, in the texture information

TI, pixels whose texture value exceeds the threshold are hatched as bleed applying candidates. In the example of FIG. 8, 90 which is an average value of the texture values of the texture information TI is used as the threshold. The reason for using the average value is that the average value is appropriate as a threshold for determining a magnitude of the texture value since a range and a distribution of the texture values in the texture information TI are considerably different for each printing medium. However, the user can set any threshold, and it is preferable to set an appropriate threshold according to the average value of the texture values. In the bleed applying processing, the bleed is applied to a pixel whose texture value exceeds the threshold among the bleed target candidate pixels Z. In the bleed-applied proof image data ZPF, the bleed applying pixels to which the bleed is applied are hatched.

A pixel value Lz after bleed applying is determined, for example, according to the following equation.

$$Lz = Le + ( {L}^{*} \_white - Le ) \times ( 1. - α ) = α \times Le + ( 1. - α ) \times {L}^{*} \_white \qquad ( q1 )$$

Here, Le is a basic proof pixel value of an edge pixel, L*_white is a basic proof pixel value of the background BG, and α is a bleed intensity coefficient. The bleed intensity coefficient α is a value larger than 0 and equal to or smaller than 1, and is set by the setting tool ZT3 in FIG. 6.

When the pixel value is a brightness, a degree of bleed increases as the bleed intensity coefficient α increases. In the embodiment, the basic proof pixel value is represented by a brightness, and the bleed intensity coefficient α is set to 1 or less. When the bleed intensity coefficient x is equal to 1.0, the pixel value Lz after bleed applying is obtained by directly copying the pixel value Le of the edge pixel. When the bleed intensity coefficient x is less than 1.0, the pixel value Lz after bleed applying is closer to the pixel value L* white of the background BG as the bleed intensity coefficient α decreases.

The pixel value Lz after bleed applying may be determined according to the following equation instead of the above equation (q1).

$$Lz = Le + ( L 0 - Le ) \times ( 1. - α ) = α \times Le + ( 1. - α ) \times L 0 \qquad ( q2 )$$

Here, L0 is a basic proof pixel value of the bleed applying pixel before the bleed applying processing. When equation (q2) is used, when the bleed intensity coefficient x is less than 1.0, the pixel value Lz after bleed applying is closer to the pixel value L0 before bleed applying as the bleed intensity coefficient α decreases.

When the bleed range is 2 or more pixels, the coefficient x is preferably decreased linearly or curvedly as a distance from the edge pixel increases such that a bleed intensity decreases as the distance from the edge pixel increases.

When the basic proof image data BPF is expressed by the CIE-L*a*b* color system, the bleed applying processing may be executed not only for the brightness L* but also for the a value and the b* value according to the above equation (q1) or equation (92). However, for the a* value and the b* value, it is preferable to copy an a* value and a b* value of the edge pixel as they are to the bleed applying pixel. Accordingly, a color tone of the edge pixel can be reflected in the bleed applying pixel. When the basic proof image data BPF is expressed by another color system, it is also possible to execute the bleed applying processing on the pixel value of the color system according to equation (q1) or equation (q2).

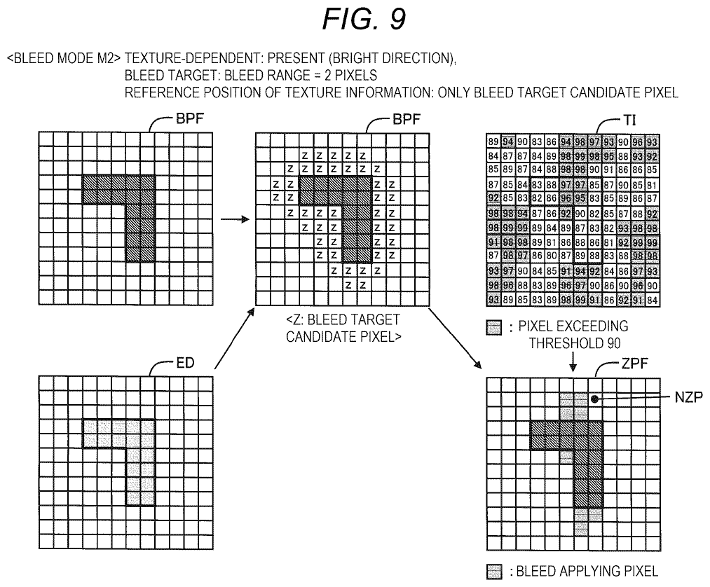

FIG. 9 is a diagram showing another example of the bleed applying processing in the bleed mode M2. The example of FIG. 9 is different from the example of FIG. 8 only in that “bleed range=2 pixels” is set. In this case, the bleed target candidate pixel Z is a pixel adjacent to the edge pixel of the basic proof image and within a range of 2 pixels from the edge pixel. In the bleed applying processing, bleed is applied to a pixel whose texture value exceeds the threshold among the bleed target candidate pixels Z. However, a pixel NZP is the bleed target candidate pixel Z and corresponds to a pixel whose texture value exceeds the threshold, but is excluded from the bleed applying pixels. This is because the texture value is equal to or smaller than the threshold in a pixel between the pixel NZP and the edge pixel. Accordingly, it is preferable to select the bleed applying pixels so as to be continuous toward an outer periphery of the edge pixel.

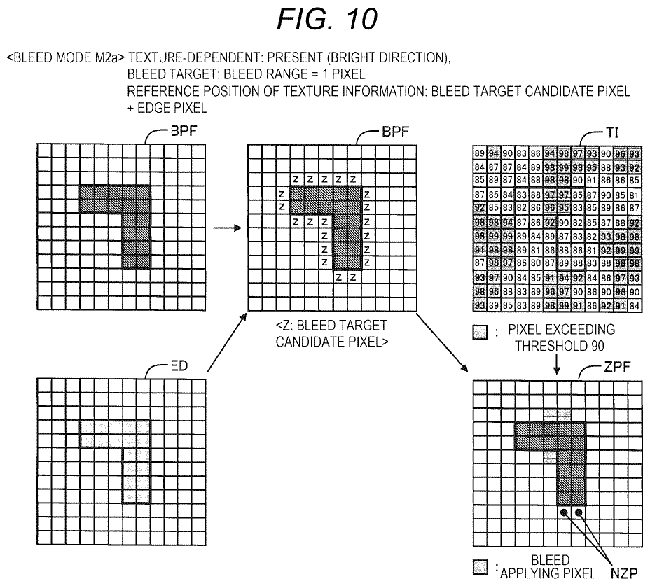

FIG. 10 is a diagram showing an example of the bleed applying processing in a bleed mode M2a. The bleed mode M2a is a type of the bleed mode M2, and is an auxiliary mode in which “reference position of texture information: bleed target candidate pixel+edge pixel” is set. FIG. 10 is different from the example of FIG. 8 only in the setting of the reference position of the texture information. In this case, in the bleed applying processing, bleed is applied to a pixel in which the texture value of the bleed target candidate pixel Z exceeds the threshold and the texture value of the edge pixel also exceeds the threshold. In the pixel NZP, the texture value of the bleed target candidate pixel Z exceeds the threshold, but the texture value of the edge pixel is equal to or smaller than the threshold, and thus the pixel NZP is excluded from the bleed applying pixels.

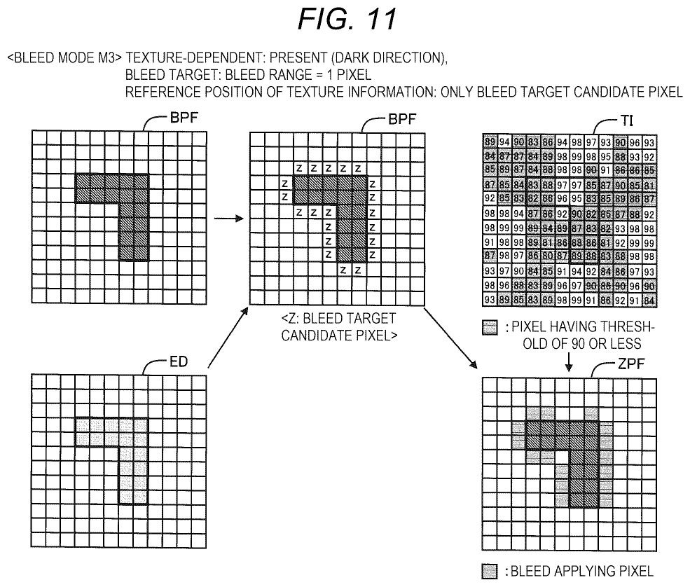

FIG. 11 is a diagram showing an example of the bleed applying processing in the bleed mode M3. The bleed mode M3 is a mode of “texture-dependent: present (dark direction)” and “bleed target: bleed range”. In this example, “bleed range=1 pixel” and “reference position of texture information: only bleed target candidate pixel” are set. Since “texture-dependent: present (dark direction)”, in the texture information TI, pixels whose texture value is equal to or smaller than the threshold are hatched as bleed applying candidates. In the bleed applying processing, bleed is applied to a pixel whose texture value is equal to or smaller than the threshold among the bleed target candidate pixels Z. In the bleed mode M3, the pixel value after bleed applying is also calculated according to the above equation (q1) or equation (q2).

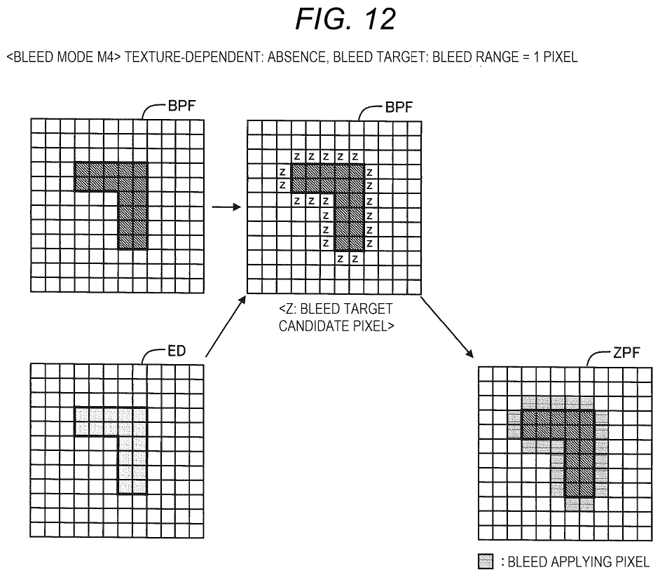

FIG. 12 is a diagram showing an example of the bleed applying processing in the bleed mode M4. The bleed mode M4 is a mode of “texture-dependent: absence” and “bleed target: bleed range”. In this example, “bleed range=1 pixel” is set. The bleed target candidate pixel Z is a pixel adjacent to the edge pixel of the basic proof image and within a range of one pixel from the edge pixel. In the bleed applying processing in the bleed mode M4, bleed is applied to all the bleed target candidate pixels Z. In the bleed mode M4, the pixel value after bleed applying is also calculated according to the above equation (q1) or equation (q2).

The bleed modes M1 and M4 described above are texture-independent modes that do not depend on the texture information. The bleed modes M2 and M3 are texture-dependent modes that depend on the texture information.

As can be understood from FIG. 6, the bleed mode M5 is a mode in which the bleed applying processing in the bleed mode M1 is executed after the bleed applying processing in the bleed mode M2. The bleed mode M6 is a mode in which the bleed applying processing in the bleed mode M1 is executed after the bleed applying processing in the bleed mode M3. Each of the modes M5 and M6 is also referred to as a “composite bleed mode”. Some of the bleed modes M1 to M6 shown in FIG. 6 may be omitted. Another bleed mode may be added.

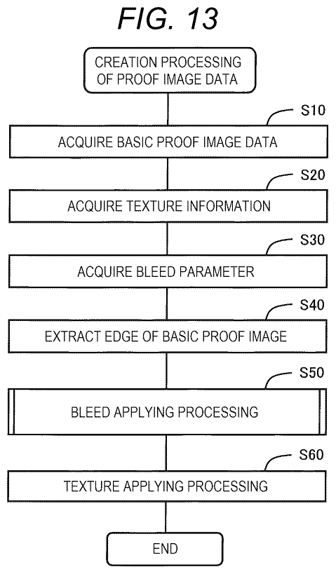

FIG. 13 is a flowchart showing a procedure of creation processing of the proof image data. In step S10, the basic proof image acquisition unit 120 acquires the basic proof image data BPF. In step S20, the texture applying unit 140 acquires the texture information TI. As described above, the texture information TI is also used in the bleed applying unit 132. In step S30, the bleed processing unit 130 acquires the bleed parameter ZP. In step S40, the edge extraction unit 131 extracts an edge of the basic proof image. In step S50, the bleed applying unit 132 executes the bleed applying processing.

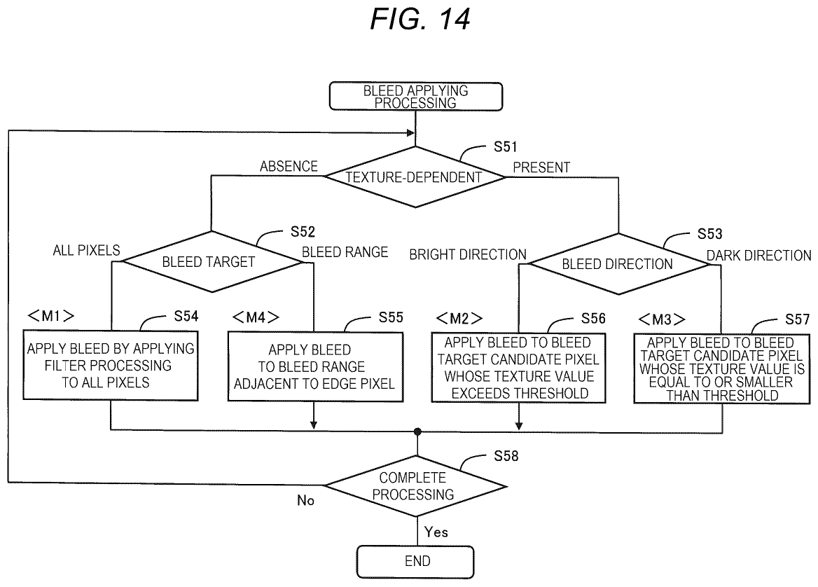

FIG. 14 is a flowchart showing a detailed procedure of the bleed applying processing in step S50. In step S51, the presence or absence of the texture-dependent is determined. In the case of the texture-independent, the processing proceeds to step S52, and it is determined whether the bleed target is all pixels or a bleed range. In the case of the texture-dependent, the processing proceeds to step S53, and it is determined whether the bleed direction is the bright direction or the dark direction. As a result, one of the bleed modes M1 to M4 is selected and executed in steps S54 to S57. In the case of the composite bleed mode M5 shown in FIG. 6, the bleed mode M2 is executed in step S56, and after it is determined in step S58 that the processing is not completed and the processing returns to step S51, the bleed mode M1 is executed in step S54. Similarly, in the case of the composite bleed mode M6, the bleed mode M3 is executed in step S57, and after it is determined in step S58 that the processing is not completed and the processing returns to step S51, the bleed mode M1 is executed in step S54.

When the bleed applying processing is completed, the texture applying unit 140 executes the texture applying processing in step S60 of FIG. 13. The order of the steps in FIGS. 13 and 14 may be changed as appropriate.

In the above embodiment, by applying the bleed applying processing to the basic proof image data BPF using the bleed parameter ZP, the bleed-applied proof image data ZPF simulating the bleed state can be obtained. It is possible to obtain the texture-applied proof image data TPF that simulates the bleed state and the texture by applying the texture applying processing to the bleed-applied proof image data ZPF using the texture information TI.

### Other Aspects:

The disclosure is not limited to the embodiments described above, and can be implemented in various aspects to the extent that the various aspects do not depart from the intent of the disclosure. For example, the disclosure can also be implemented in the following aspects. To solve some or all of the problems described in the disclosure, or to achieve some or all of the effects of the disclosure, technical features of the embodiments described above that correspond to the technical features in each of the following aspects can be replaced or combined as appropriate. Further, the technical features can be deleted as appropriate unless described as essential features in the present specification.

(1) According to a first aspect of the disclosure, a method for creating proof image data is provided. The method includes: (a) acquiring basic proof image data for reproducing, by a proof output device, a color of a printed matter to be printed on a printing medium using a printing machine; and (b) creating, by applying bleed applying processing to the basic proof image data using a bleed parameter representing a bleed state of an ink in the printed matter, bleed-applied proof image data simulating the bleed state.

According to this method, the proof image data simulating the bleed state can be obtained.

(2) The method may further include (c) creating, by applying texture applying processing to the bleed-applied proof image data using texture information representing a texture of the printing medium, texture-applied proof image data simulating the texture.

According to this method, the texture-applied proof image data that simulates the bleed state and the texture can be obtained.

(3) In the above method, the bleed parameter may include a bleed range parameter defining a bleed range, and the (b) may include (b1) extracting an edge of a basic proof image represented by the basic proof image data, and (b2) applying bleed to a pixel value of the basic proof image data in a bleed target region adjacent to the edge and extending over the bleed range.

According to this method, a region to which bleed is applied can be changed by adjusting the bleed range parameter.

(4) In the method, the bleed applying processing may include a texture-dependent mode depending on the texture information, the texture information may include a texture value for each pixel, and the bleed parameter related to the texture-dependent mode may include a bleed direction parameter indicating whether to apply the bleed according to whether a magnitude relationship between the texture value and a threshold is a first magnitude relationship or a second magnitude relationship. In the texture-dependent mode, the (b2) may be executed to apply the bleed to the pixel value of the basic proof image data for a pixel determined to apply the bleed according to the bleed direction parameter in the bleed target region.

According to this method, a pixel to which bleed is applied can be changed by adjusting the bleed direction parameter.

(5) In the method, the bleed applying processing may further include a texture-independent mode in which bleed is applied to all pixels without depending on the texture information, and when the bleed parameter includes a first parameter related to the texture-dependent mode and a second parameter related to the texture-independent mode, the (b) may apply blurring filter processing to all the pixels according to the second parameter after the (b1) and (b2) are executed according to the first parameter.

According to this method, bleed over the entire proof image can be applied in addition to bleed in the vicinity of the edge.

(6) In the method, the bleed applying processing may include a mode in which bleed is applied to all pixels, and the (b) may include applying blurring filter processing to all pixels of a basic proof image represented by the basic proof image data.

According to this method, bleed over the entire proof image can be applied.

(7) According to a second aspect of the disclosure, a proof image data creation device is provided. The proof image data creation device includes: a basic proof image acquisition unit configured to acquire basic proof image data for reproducing, by a proof output device, a color of a printed matter to be printed on a printing medium using a printing machine; and a bleed processing unit configured to create, by applying bleed applying processing to the basic proof image data using a bleed parameter representing a bleed state of an ink in the printed matter, bleed-applied proof image data simulating the bleed state.

(8) According to a third aspect of the disclosure, a computer program for creating proof image data is provided. The computer program causes a computer to execute: (a) processing of acquiring basic proof image data for reproducing, by a proof output device, a color of a printed matter to be printed on a printing medium using a printing machine; and (b) processing of creating, by applying bleed applying processing to the basic proof image data using a bleed parameter representing a bleed state of an ink in the printed matter, bleed-applied proof image data simulating the bleed state.

The disclosure can be implemented in various aspects other than the above-described aspects, and can be implemented as, for example, a computer program for implementing the function of the proof image data creation device. For example, the disclosure can be implemented in the form of a non-transitory storage medium on which the computer program is recorded.

What is claimed is:

1. A method for creating proof image data, the method comprising:
(a) acquiring basic proof image data for reproducing, by a proof output device, a color of a printed matter to be printed on a printing medium using a printing machine; and
(b) creating, by applying bleed applying processing to the basic proof image data using a bleed parameter representing a bleed state of an ink in the printed matter, bleed-applied proof image data simulating the bleed state.

2. The method according to claim 1, further comprising:
(c) creating, by applying texture applying processing to the bleed-applied proof image data using texture information representing a texture of the printing medium, texture-applied proof image data simulating the texture.

3. The method according to claim 2, wherein
the bleed parameter includes a bleed range parameter defining a bleed range, and
the (b) includes
(b1) extracting an edge of a basic proof image represented by the basic proof image data, and
(b2) applying bleed to a pixel value of the basic proof image data in a bleed target region adjacent to the edge and extending over the bleed range.

4. The method according to claim 3, wherein
the bleed applying processing includes a texture-dependent mode depending on the texture information,
the texture information includes a texture value for each pixel,
the bleed parameter related to the texture-dependent mode includes a bleed direction parameter indicating whether to apply the bleed according to whether a magnitude relationship between the texture value and a threshold is a first magnitude relationship or a second magnitude relationship, and
in the texture-dependent mode, the (b2) is executed to apply the bleed to the pixel value of the basic proof image data for a pixel determined to apply the bleed according to the bleed direction parameter in the bleed target region.

5. The method according to claim 4, wherein
the bleed applying processing further includes a texture-independent mode in which bleed is applied to all pixels without depending on the texture information, and
when the bleed parameter includes a first parameter related to the texture-dependent mode and a second parameter related to the texture-independent mode,
the (b) applies blurring filter processing to all the pixels according to the second parameter after the (b1) and (b2) are executed according to the first parameter.

6. The method according to claim 1, wherein
the bleed applying processing includes a mode in which bleed is applied to all pixels, and
the (b) includes applying blurring filter processing to all pixels of a basic proof image represented by the basic proof image data.

7. A proof image data creation device comprising:
a basic proof image acquisition unit configured to acquire basic proof image data for reproducing, by a proof output device, a color of a printed matter to be printed on a printing medium using a printing machine; and
a bleed processing unit configured to create, by applying bleed applying processing to the basic proof image data using a bleed parameter representing a bleed state of an ink in the printed matter, bleed-applied proof image data simulating the bleed state.

8. A computer program for creating proof image data, the computer program causing a computer to execute:
(a) processing of acquiring basic proof image data for reproducing, by a proof output device, a color of a printed matter to be printed on a printing medium using a printing machine; and
(b) processing of creating, by applying bleed applying processing to the basic proof image data using a bleed parameter representing a bleed state of an ink in the printed matter, bleed-applied proof image data simulating the bleed state.
